(19) United States
(12) Patent Application Publication
(10) Pub. No.: US 2021/0257891 A1
(43) Pub. Date: Aug. 19, 2021

(54) METHOD OF MANUFACTURING AN ACTUATOR MOTOR SHAFT WITH TOOTHINGS AND BEARING SEAT

(71) Applicant: Nidec Corporation, Kyoto (JP)

(72) Inventors: Pascual GUARDIOLA, Ingersheim (DE); Uwe LASEBNICK, Stuttgart (DE)

(21) Appl. No.: 17/174,419

(22) Filed: Feb. 12, 2021

(30) Foreign Application Priority Data
Feb. 13, 2020 (DE) 102020103729.5

(51) Int. Cl. H02K 15/14; H02K 7/08; H02K 7/116

(52) U.S. Cl. CPC H02K 15/14; H02K 7/116; H02K 7/083

(57) ABSTRACT

A method of manufacturing a motor shaft of an electric motor which is part of an actuator providing a rotary actuating movement of an actuator through a transmission, includes providing a cylindrical shaft blank including a second end and a second end portion extending from the second end. An outside diameter of the second end portion is greater than outside diameters of all remaining portions of the shaft. The method further includes forming a toothing into the second end portion, and grinding the toothing to size in a region spaced from the second end to define a bearing seat, an outside diameter of the bearing seat being less than an outside diameter of an engagement region of the toothing between the bearing seat and the second end.

### CROSS REFERENCE TO RELATED APPLICATION

The present application claims priority under 35 U.S.C. § 119 to German Patent Application No. 102020103729.5 filed on Feb. 13, 2020, the entire contents of which are hereby incorporated herein by reference.

### 1. FIELD OF THE INVENTION

The present invention relates to a method of manufacturing a motor shaft of an actuator, and to an actuator including a motor shaft.

### 2. BACKGROUND

Electric motor actuators are used in a variety of different applications, for example in oil pumps. They provide a linear and/or rotational positioning movement for an actuator operated by the actuator. Electromotive actuators known from practice have an electric motor, which is, for example, a brushless DC motor. The motor shaft of the electric motor is mounted in roller bearings so that it can rotate about the axis of rotation. A gearing transmits the rotary motion of the motor shaft to the actuator. It is known to provide a toothing or splines at one end of the motor shaft, in which a part of the gearing engages. Conventionally, the motor shaft has a bearing seat for mounting the shaft in the roller bearing immediately behind the toothing. Both the bearing seat and the gear teeth are formed separately on the motor shaft in several machining steps. This machining is costly.

### SUMMARY

Example embodiments of the present disclosure provide methods of manufacturing motor shafts of actuators which are simple and inexpensive, while maintaining consistent quality.

An example embodiment of the present disclosure provides a method of manufacturing a motor shaft of an electric motor which is included in an actuator providing a rotational actuating movement for an actuator through a transmission, the method including providing a cylindrical shaft blank including a second end and a second end portion extending from the second end, an outside diameter of the second end portion being greater than outside diameters of remaining portions of the shaft, forming a toothing in the second end portion, and grinding the toothing to size in an area spaced away from the second end to form a bearing seat, an outside diameter of the bearing seat being less than an outside diameter of an engagement area of the toothing between the bearing seat and the second end.

By forming a toothing in the entire end area, the bearing seat can be formed by simply grinding the toothing, which saves steps and costs. The grinding process also allows the bearing seat to be produced with required quality. Since the toothing is formed before the bearing seat, it is not necessary to provide a clearance or recess between the engagement area and the bearing seat, which was previously required because in the prior art, the toothing was formed last and the tool used to hob the toothing was too large for the small dimensions of the shaft and the bearing seat was damaged by the tool. Since the bearing seat is now directly adjacent to the engagement area, the strength of the shaft is increased. The gear geometry in the area of the bearing seat also has the advantage that the bearing inner ring can be cooled better. In the case of a fluid pump, especially an oil pump, the fluid flows through the areas between the ground teeth and cools the bearing inner ring.

The blank is preferably produced by cold pressing or by a machining process of a cylindrical semi-finished product with a constant diameter.

It is advantageous if small unevennesses are removed in the engagement area during the grinding process in order to achieve a specific required quality such as, for example, what is currently specified as IT 6.

Preferably, the toothing in the meshing area defines a gear wheel, and in particular a sun wheel.

It is advantageous if the second end region is hardened by induction hardening. Machining of the entire workpiece can thus be avoided, which also saves costs. The hardening process is preferably carried out before the bearing seat is formed.

The toothing can be formed into the surface of the shaft by hobbing, for example. The close tolerance specification of IT can be achieved by hobbing. In one example embodiment, the actuator is structured to convey a fluid of a pump of a motor vehicle, in particular, an impeller of an oil pump.

An example embodiment of an actuator unit according to the present disclosure includes an actuator, a gear assembly and an electric motor to rotationally drive the actuator through the gear assembly. The electric motor includes a motor shaft which in a second end region includes a bearing seat to receive a rolling bearing to mount in a housing. An engagement region in which at least one component of the gear assembly engages to transmit the rotational movement of the motor shaft to the actuator adjoins the bearing seat towards the second end. The bearing seat and the engagement area include a continuous toothing which is ground to size in an area of the bearing seat and defines a gearwheel in the engagement area.

In one example embodiment of the present disclosure, the actuator is structured to convey a fluid of a pump, in particular, an impeller of an oil pump, and the gear is a planetary gear, the gear of the motor shaft defining the sun gear.

The electric motor is preferably a brushless DC motor, in particular, an internal rotor.

Also provided is an automatic transmission assembly of a motor vehicle including an actuator described above. Preferably, the actuator includes an electric oil pump which decouples the transmission control from the drive engine. The transmission is thus ready to shift even when the internal combustion engine is switched off or the engine speed is low. The motor vehicle is preferably a hybrid vehicle.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Identical or functionally identical components are provided with the same reference numbers in the drawing figures.

FIG. 1 shows a longitudinal section through an electric motor of an actuator with a motor shaft according to an example embodiment of the present disclosure.

FIG. 2 shows a spatial view of the motor shaft.

### DETAILED DESCRIPTION

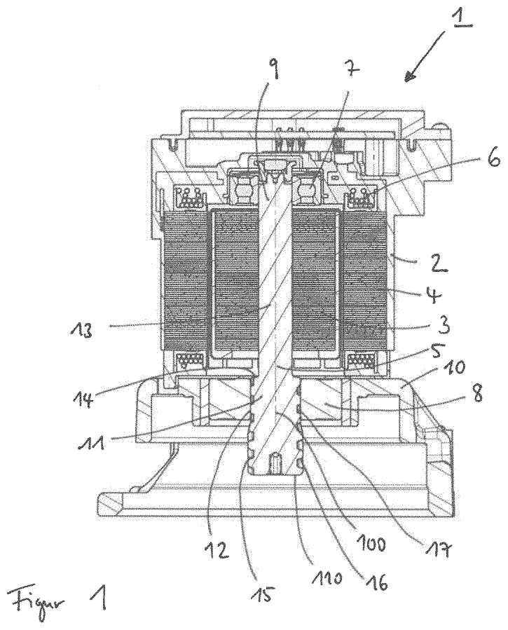

FIG. 1 shows a brushless DC motor 1. A rotor 3 and a stator 4 are provided in a motor housing 2. The stator 4 surrounds the rotor 3 concentrically relative to an axis of rotation 100. The rotor 3 is connected to a motor shaft 5 to transmit a torque. The stator 4 includes a stator core which extends coaxially with the axis of rotation 100 and includes a plurality of stator core segments around each of which coils 6 are wound. The stator 4 is fixedly mounted within the motor housing 2 and is adapted to generate a time-varying magnetic field via the coils 6. The rotor 3 is adapted to be rotated by an interaction with the time-varying magnetic field generated by the coils 6.

The motor shaft 5 is mounted in rolling bearings 7,8 so as to be rotatable about the axis of rotation 100. A first rolling bearing 7 is mounted in the motor housing 2 and supports the motor shaft 5 in a first end region 9. A second rolling bearing 8 is mounted in a housing cover 10 and supports the motor shaft 5 in a second end region 11, which is opposite the first end region 9. The housing cover 10 closes the motor housing 2. The motor shaft 5 includes a bearing seat 12 in the second end region 11 for the inner ring of the second rolling bearing 8, which is not shown. In the region of the bearing seat 12, the outer diameter of the motor shaft 5 is larger than in an intermediate region 13 of the motor shaft adjoining the second end region 11 and the first end region 9 adjoining it in turn. The end of the bearing seat 12 remote from the second end 110 of the motor shaft 5 is thus defined by a circumferential shoulder 14. Directly adjoining the bearing seat 12 is an engagement area 15 in the direction of the second end 110, in which a sun gear 16 is provided on the surface of the motor shaft. The gear toothing 17 extends over the bearing seat 12 to the second end 110 of the motor shaft 5. Only in the engagement area 15 do planetary gears of the gear assembly not shown engage in the sun gear 16 in the installed state. The gearbox is a planetary gear. The outer diameter of the motor shaft 5 increases toward the engagement area 15.

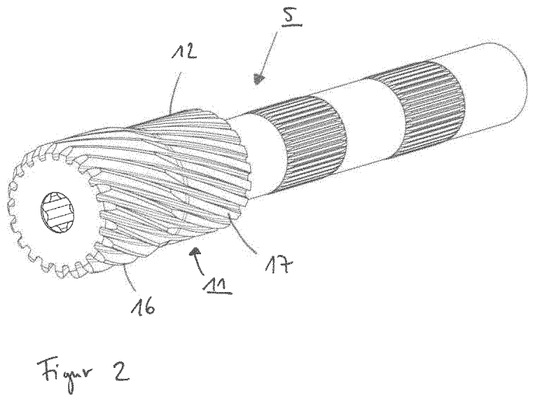

FIG. 2 shows the motor shaft 5 in an isometric view. In the manufacture of the motor shaft 5, a cylindrical semi-finished product of uniform diameter is machined in such a way that the shaft has a smaller outer diameter in the intermediate region 13 and in the first end region 9, and thus outside the second end region 11, than the second end region 11 still to be machined. This is achieved either by cold forging or by a machining process of the semi-finished product. In the cold forging option, the semi-finished product is assumed to have a smaller diameter and the larger diameter for the gear tooth area and the bearing seat is obtained by the cold forming process. In the second option, the entire diameter of the blank is designed for the largest diameter and the areas with smaller diameters are created via machining processes, such as turning or grinding.

In the blank produced by the aforementioned machining, the gearing 17 is introduced into the surface of the motor shaft 5 in the entire second end region 11 by bobbing in a next machining step. The second end region 11 is then partially hardened by induction hardening.

Finally, in the engagement area 16, minimal unevenness is removed by grinding in order to achieve IT 6 accuracy, and in the area of the bearing seat 12, the motor shaft 5 is ground to size in diameter, such that the bearing seat 12 is produced very accurately, process reliably, and with the required quality of IT6 at comparatively low cost.

In an example embodiment of the present disclosure, the motor shaft 5 is used in an electric oil pump of a hybrid vehicle that is part of an automatic transmission. Conventionally, the combustion engine drives an oil pump, which in turn builds up the necessary control pressure. When the combustion engine stops, the pump also stops and the pressure drops. The electrically driven oil pump ensures permanent control pressure in the transmission and thus immediate readiness for shifting even when the combustion engine is switched off.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A method of manufacturing a motor shaft of an electric motor which is part of an actuator providing a rotary actuating movement for an actuating element through a transmission, the method comprising:
providing a cylindrical shaft blank including a second end and a second end portion extending from the second end, an outside diameter of the second end portion being greater than outside diameters of all remaining portions of the motor shaft;
forming a toothing into the second end portion; and
grinding the toothing to size in a region spaced apart from the second end to form a bearing seat, an outside diameter of the bearing seat being less than an outside diameter of an engagement portion of the toothing formed between the bearing seat and the second end.

2. The method according to claim 1, wherein the toothing forms a gear wheel in the engagement portion.

3. The method according to claim 1, wherein the second end portion is hardened through induction hardening.

4. The method according to claim 1, wherein the toothing is introduced into a surface of the motor shaft using tooth flank cutting.

5. An actuator apparatus, comprising:
an actuator;
a gear assembly;
an electric motor to rotationally drive the actuator through the gear assembly;
a motor shaft included in the electric motor, the motor shaft including a bearing seat to receive a rolling bearing to be mounted in a housing in a second end portion, an engagement portion adjoining the bearing seat adjacent to a second end such that at least one component of the transmission engages to transmit rotational movement of the motor shaft to the actuator;
wherein the bearing seat and the engagement portion include a continuous toothing which is ground to size at the bearing seat and defines a toothed wheel in the engagement portion.

6. The actuator apparatus according to claim 5, wherein
the actuator is structured to convey a fluid of a pump;
the gear assembly includes a planetary gear; and
a gear of the motor shaft defines a sun gear which interfaces with the planetary gear.

7. An automatic transmission apparatus of a motor vehicle comprising the actuator apparatus according to claim 6.

8. A hybrid vehicle comprising the automatic transmission apparatus according to claim 7.
